(19) United States
(12) Patent Application Publication
(10) Pub. No.: US 2010/0240001 A1
(43) Pub. Date: Sep. 23, 2010

(54) DEVICE AND METHOD FOR SCANNING A DENTAL MODEL

(76) Inventor: Heinrich Steger, Bruneck (IT)

Correspondence Address: LERNER GREENBERG STEMER LLP, P O BOX 2480, HOLLYWOOD, FL, 33022-2480, US

(21) Appl. No.: 12/726,780

(22) Filed: Mar. 18, 2010

(30) Foreign Application Priority Data
Mar. 18, 2009 (AT) A 431/2009

(51) Int. Cl. A61C 11/08; H04N 13/02

(52) U.S. Cl. 433/54; 348/46; 348/E13.074

(57) ABSTRACT

A device producing a computer-processable, three-dimensional image of a dental model includes a scanner that generates scanned data and an electronic memory unit, wherein the scanned data of the dental model that are captured by the scanner in a scanning area are stored. The device has a positioning area in which a temporomandibular joint movement simulator, preferably an articulator, with dental model halves of the dental model arranged therein can be arranged such that at least sections of the TMJ movement simulator can be housed or are housed in the scanning area of the scanner.

### CROSS-REFERENCE TO RELATED APPLICATION

This application claims the priority, under 35 U.S.C. §119, of Austrian patent application A 431/2009, filed Mar. 18, 2009; the prior application is herewith incorporated by reference in its entirety.

### BACKGROUND OF THE INVENTION

### Field of the Invention

The invention relates to a device and a method for producing a computer-processable, three-dimensional image, based on scanned data, of a dental model. The device includes a scanner and an electronic memory unit, wherein the scanned data of the dental model that are captured by the scanner in a scanning area can be fed as a signal to the electronic memory unit.

Such devices and methods are already known from the state of the art and are used primarily to digitally capture the impression of a set of teeth of a person or an already modified impression model of a set of teeth, in particular its surface form.

For some time now the two modeled halves of sets of teeth have been separately scanned one after the other and the scanned data then consolidated virtually, with the result that the best possible positioning of the set of teeth and a matching of the respective halves of the set of teeth according to the positioning of the set of teeth is created in the virtual domain.

For example, patent application publication No. US 2004/172150 A1 and its corresponding German utility model DE 202 20 873 U1 show how the movement of the temporomandibular joint is simulated using a so-called virtual articulator. A disadvantage with this is that the matching of the halves of the set of teeth is only simulated virtually, which can necessarily lead to problems when applied in reality, as the purely virtually simulated temporomandibular joint movement often does not correspond to the actual positioning of the set of teeth.

German patent DE 103 01 958 B4 describes a method of preparing a dental implant for an intraoral implantation field. The document primarily shows the overlaying and allocation of tomographically captured location marks to a laboratory planning model using the tomographic reference. The positioning of the patient's set of teeth is captured by means of an axiograph which can be carried out in automated manner by a laser scanner.

U.S. Pat. No. 7,596,287 B2 and its corresponding European published patent application EP 1 406 555 further show a method and a device for the three-dimensional determination and digitization of a dental model. It is shown that a dental technician can also take account of the counterbite of the other jaw via the existing plaster model. The whole plaster model is scanned—as it turns—in one procedure by a stripe scanner.

A major problem with the devices and methods from the state of the art is that the actual solid-angle position of the two halves of a set of teeth relative to each other is not digitally captured. Moreover, the experience of a trained dental technician makes no contribution to a purely virtually created articulator when matching halves of sets of teeth.

### SUMMARY OF THE INVENTION

It is accordingly an object of the invention to provide a scanning device and method which overcome the a variety of disadvantages of the heretofore-known devices and methods of this general type and which provides for a device that is improved compared with the state of the art and an improved method for producing images of dental models. In particular a dental technician is to have the possibility during the digitizing of the dental model of producing as ideal a position as possible of halves of sets of teeth or of dental model halves and of having these scanned. Preferably, it is further to be made possible to capture a solid-angle position of the halves of a set of teeth that corresponds to reality. Preferably, the possibilities of the scanners used hitherto (stripe-light scanners) are to be broadened.

With the foregoing and other objects in view there is provided, in accordance with the invention, a device for producing a computer-processable, three-dimensional image of a dental model having two halves, comprising:

a scanner for capturing scanned data of the dental model disposed in a scanning area;

an electronic memory unit connected to receive signals with the scanned data of the dental model from the scanner in a scanning area;

a TMJ motion simulator (TMJ=temporomandibular joint) for holding the two halves of the dental model in, or for movement into, the scanning area of the scanner.

In other words, the objects of the invention are achieved in that the device has a positioning area in which a TMJ motion simulator (i.e., a temporomandibular joint movement simulator), preferably an articulator, with halves of the dental model arranged therein can be disposed such that at least sections of the temporomandibular joint movement simulator can be housed or are housed in the scanning area of the scanner. As a result, the previous purely virtual positioning of the scanned-in halves of the set of teeth is not carried out, but is replaced by a manual positioning of the halves of the set of teeth relative to each other, which is more ideal thanks to the experience of the dental technician.

The positioning area is defined as the area in which the articulator can be arranged so that a dental model to be scanned is situated in a scanning area of the scanner of the device. The scanning area is in turn defined as the space in which at least the areas of a dental model that are relevant for a matching of halves of a set of teeth can be captured by a scanner. The positioning area of the articulator and the scanning area of the scanner are thus to overlap at least in the area in which the dental model or at least its relevant areas can be arranged.

According to a preferred embodiment of the present invention the device may be provided with a drive unit which moves the dental model relative to the scanner. On the one hand this relative movement can take place by having the drive unit move either a dental model half or the housable or housed temporomandibular joint movement simulator with the two halves of the dental model arranged therein in the scanning area relative to the scanner, or on the other hand by having the drive unit move the scanner relative to a dental model half or relative to the temporomandibular joint movement simulator. It is essential that the capture angle between scanned dental model and scanner changes during the scanning.

A particularly preferred embodiment of the present invention can provide that the device comprises a casing in which at least the scanner, the scanning area and the positioning area are arranged. Such a casing serves above all to integrate all the components in a device.

Preferably, it can be provided to this end that the TMJ motion simulator can be secured in the positioning area—preferably to the casing via a positioning element—such that the dental model halves of the dental model lie in the scanning area of the scanner.

In order to obtain a releasable connection of the temporomandibular joint movement simulator to the device it can be provided that the temporomandibular joint movement simulator can be magnetically secured to the casing. Other releasable forms of attachment, such as for example a releasable snap connection, can naturally also be used.

In order to improve or make easier the digitization and the presentation of the dental models for an operator, it can be provided that the scanned data from the electronic memory unit can be fed in prepared form via a processor to a screen and can be presented via this as an image of the dental model.

With the above and other objects in view there is also provided, in accordance with the invention, a method for generating a three-dimensional image of a dental model with two halves. The method includes the following steps, which may be carried out in a sequential order that is different from the following:

scanning of a first dental model half by a scanner and storage of the scanned data in an electronic memory unit,

scanning of a second dental model half by the scanner and storage of the scanned data in the electronic memory unit,

preferably manual positioning and matching of the first dental model half and the second dental model half to each other in a temporomandibular joint movement simulator, preferably in an articulator,

scanning of the two dental model halves arranged matched to each other in the temporomandibular joint movement simulator by the scanner and storage of the scanned data in the electronic memory unit,

consolidation of the scanned data from the first dental model half, the scanned data from the second dental model half and the scanned data from the jointly scanned dental model halves to form an image of the dental model.

This is substantially easier and improved compared with the state of the art because after (or also before) the detailed scanning of the two halves of the set of teeth a dental technician can use his or her experience to manually match the two halves of the set of teeth to each other or position them and the resultant solid-angle position of the halves of the set of teeth relative to each other is then once again scanned. A software program then overlays the pictures of the two dental model halves that are arranged in the articulator with the previously produced (or also subsequently scanned) details of the halves of the set of teeth to produce a single image of the dental model which contains both the precise surface form of the individual dental model halves and their solid-angle position relative to each other.

According to a preferred embodiment of this method according to the invention it can be provided that the scanned data, which preferably correspond in each case to a point set, are mathematically consolidated by a computer program to form an image of the dental model (common scanned data set). Each point of the scanned surface corresponds to the smallest resolution unit of the scanner. The surface form of the scanned object is thus obtained virtually through the plurality of captured points. The computer program (software) preferably recognizes similar patterns in the scanned data from the two individual dental model halves compared with the scanned data from the dental model halves arranged in the articulator, whereby an automatic virtual overlaying of these images to form a single image of the dental model can take place.

A further preferred embodiment can provide that the individual scanned data and/or the consolidated image of the data model are/is clearly presented on a screen for an operator. The three individual images/the scanned data can thus be displayed on the screen and/or also the consolidated overall image. A preferred embodiment example of the present invention can also provide that the scanned data and/or the image of the data model are/is fed to a memory unit inside the device or an external memory unit and are/is stored in this.

Other features which are considered as characteristic for the invention are set forth in the appended claims.

Although the invention is illustrated and described herein as embodied in a device for scanning a dental model image with articulator, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic representation of a scanning procedure;

FIG. 2 is a perspective view of a device with an articulator;

FIG. 3 is a view of the articulator arranged in the casing;

FIG. 4 is a view according to FIG. 3 with the casing door; and

FIG. 5 is a cross-section taken through the device according to FIG. 4.

### DETAILED DESCRIPTION OF THE INVENTION

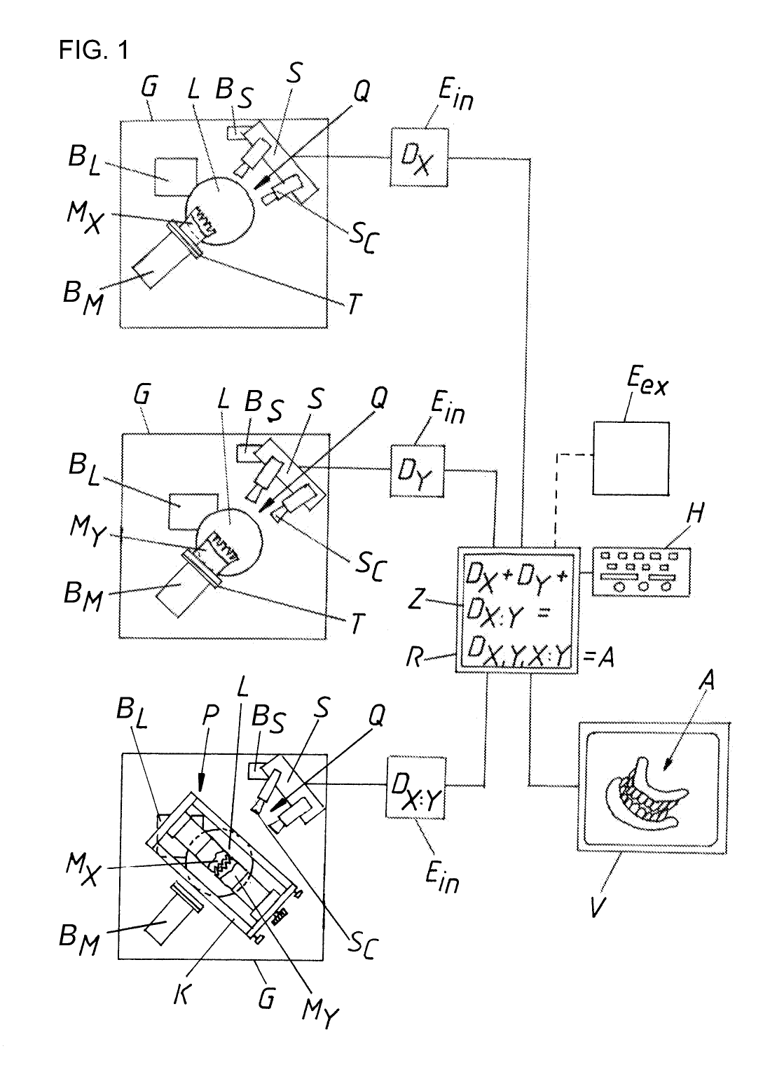

Referring now to the figures of the drawing in detail and first, particularly, to FIG. 1 thereof, there is shown a schematic sequence of a method for producing a computer-processable, three-dimensional image A, based on scanned data D, of a dental model M. In the top left area it can be seen how a first dental model M_{X} is arranged in a scanning area Q. The dental model M_{X} is held on a clamping device, here on a securing plate T. The whole of the securing plate T can be moved by a drive unit B_{M} in the scanning area Q relative to the scanner S. Preferably, the whole of the dental model M_{X} can be moved in all spatial positions and spatial planes relative to the scanner S, with the result that the surface form of the dental model M_{X} can be captured in as much detail as possible. Further, a drive unit B_{L} for the positioning plate L and a drive unit B_{S} for the scanner, or the scanner head, are also schematically shown. The scanned data D_{X} captured by the scanner are saved or buffered in the internal memory Eᵢₙ.

In a next step of the procedure, as shown center left, the dental model M_{Y} is captured in the same way as the first dental model M_{X} and the scanned data D_{Y} that have been scanned are stored in the memory Eᵢₙ.

Subsequently (bottom left) the temporomandibular joint movement simulator K (articulator or TMJ motion simulator) is brought or set into a positioning area P of the device. The TMJ motion simulator or articulator K is preferably magnetically held against the positioning element L, plate-shaped here, whereby the dental model halves M_{X} and M_{Y} arranged in the articulator K are housed in the scanning area Q of the scanner S. During the scanning process, the entire articulator K or only the dental model halves M_{X} and M_{Y} move such that the tooth position of the teeth relative to one another can be captured by the scanner S. The thus-captured scanned data D_{X:Y} are then stored in turn in an internal memory Eᵢₙ.

The saved and captured scanned data D_{X}, D_{Y} and D_{X:Y} are then brought together in the computer program R with the help of the processor Z and consolidated into a scanned data set D_{X, Y, X:Y} which then corresponds to the image A, displayed on the screen V, of the dental model D. Both the single data D_{X}, D_{Y} and D_{X:Y} and the consolidated data D_{X, Y, X:Y} can then be kept or stored in an internal memory Eᵢₙ or also in an external memory Eₑₓ. Also shown schematically is the control unit H which allows the operator to intervene in the scanned data D consolidation procedure that is otherwise as automatic as possible.

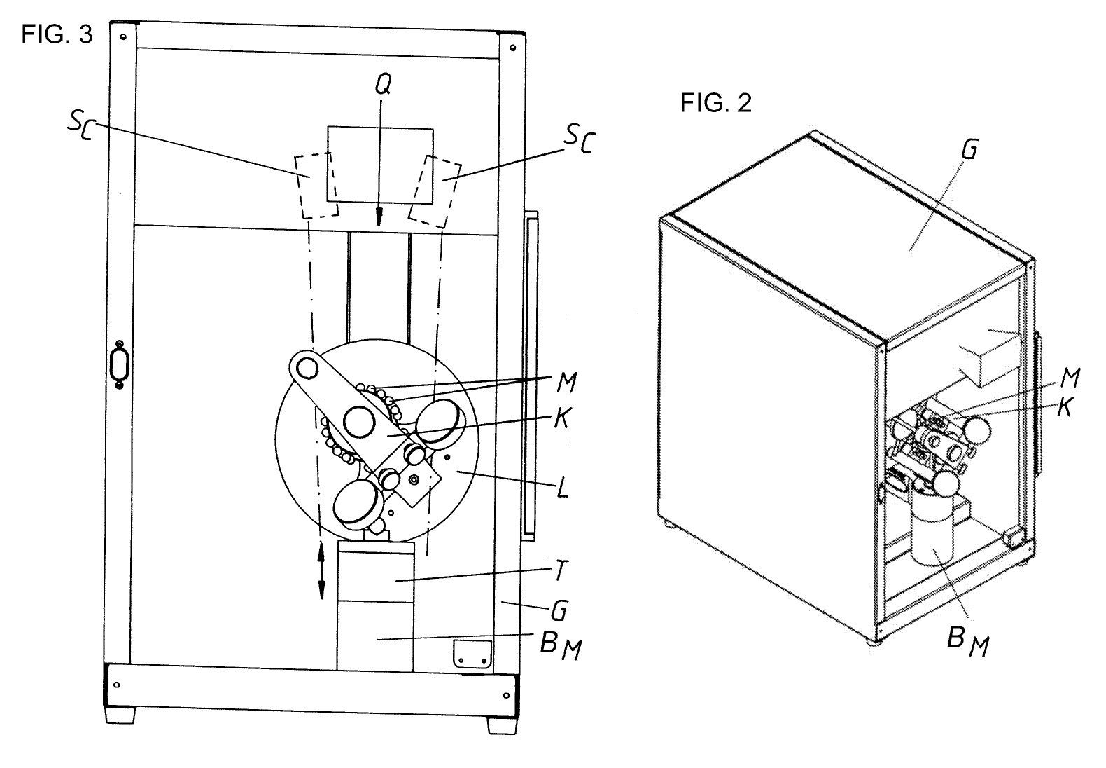

FIG. 2 shows a perspective view of the casing G of the device, wherein the articulator K arranged in the casing G can be seen with the dental models M schematically represented here as a plurality of cylinders and the drive unit B_{M}.

In FIG. 3 a view of the scanning device is shown, wherein the temporomandibular joint movement simulator K with the dental models M again schematically shown therein as cylinders is attached to the positioning plate L. The two individual cameras S_{C} of the scanner S used here, which define the scanning area Q that can be captured through their position relative to each other, are shown as broken lines in this FIG. 3 (see also the schematic dot-dash lines in FIG. 5). This figure also shows that the securing plate T is designed in two parts in this embodiment example, wherein the upper part can be telescopically moved relative to the other, which is useful above all if a single dental model half M_{X} or M_{Y} (without articulator K) is to be moved in the scanning area Q.

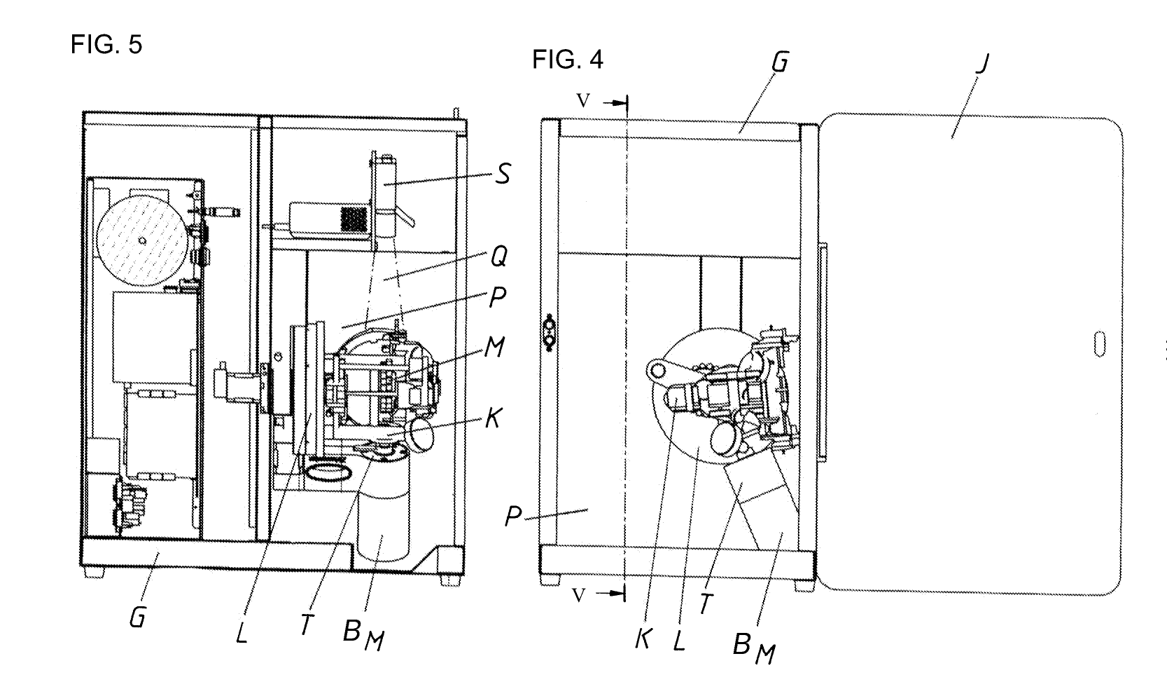

In FIG. 4 the casing G with the articulator K located therein is represented in a similar way to that in FIG. 3, but the casing door J can additionally be seen.

FIG. 5 shows the cross-section taken along the section line V-V of the scanning device of FIG. 4. A cross-section through the positioning element or through the positioning plate L is also shown, which preferably magnetically holds the whole of the articulator K with the dental model M that can be arranged therein in the positioning area P. The positioning area P is essentially the whole of the space defined by the casing G. Accordingly the positioning area P of the articulator K and the scanning area Q of the scanner S are provided or represented in the casing G, in which the dental model halves M_{X} and M_{Y} can be arranged.

An improved and simplified form of producing an image of a dental model is thus shown by the present invention, wherein above all the result of the positioning of an articulator in a scanning area is that the ideal position established in the articulator by a person skilled in the art of dental model halves relative to each other can be captured and can be mathematically consolidated by detailed scans of the individual dental models into a single, detailed, three-dimensional, storable image of a dental model.

1. A device for producing a computer-processable, three-dimensional image of a dental model having two halves, comprising:
a scanner for capturing scanned data of the dental model disposed in a scanning area;
an electronic memory unit connected to receive signals with the scanned data of the dental model from said scanner in a scanning area;
a TMJ motion simulator holding the two halves of the dental model in, or for movement into, the scanning area of said scanner.

2. The device according to claim 1, wherein said TMJ motion simulator is an articulator configured to move the halves of the dental model relative to one another.

3. The device according to claim 1, which comprises a drive unit for moving the dental model relative to said scanner.

4. The device according to claim 3, wherein said drive unit is configured to move a dental model half or the housable or housed TMJ motion simulator with the two halves of the dental model arranged therein relative to said scanner in the scanning area.

5. The device according to claim 3, wherein said drive unit is configured to move said scanner relative to a dental model half or relative to said TMJ motion simulator.

6. The device according to claim 1, which comprises a casing enclosing at least said scanner, the scanning area, and a positioning area.

7. The device according to claim 6, wherein said TMJ motion simulator is securable in the positioning area such that the dental model halves of the dental model lie in the scanning area of said scanner.

8. The device according to claim 7, which comprises a positioning element for securing said TMJ motion simulator to said casing in the positioning area.

9. The device according to claim 7, wherein said TMJ motion simulator is magnetically secured to said casing.

10. The device according to claim 1, wherein scanned data from said electronic memory unit are to a processor and displayed, in processed form, on a screen as an image of the dental model.

11. A method of generating a computer-processable, three-dimensional image of a dental model formed of two halves, the method which comprises:
providing a device according to claim 1;
scanning a first half of the dental model with the scanner and storing first scanned data in the electronic memory unit;
scanning a second half of the dental model with the scanner and storing second scanned data in the electronic memory unit;
placing the first half and the second half of the dental model in a matched relationship in the TMJ motion simulator;
jointly scanning the first and second halves of the dental model in the matched relationship in the TMJ motion simulator with the scanner and storing resulting scanned data in the electronic memory unit; and
consolidating the first scanned data from the first half, the second scanned data from the second half, and the scanned data from the jointly scanned first and second halves to form the image of the dental model.

12. A method of generating a three-dimensional image of a dental model, the method which comprises:
scanning a first half of the dental model with a scanner and storing first scanned data in an electronic memory unit;
scanning a second half of the dental model with the scanner and storing second scanned data in the electronic memory unit;
placing the first half and the second half of the dental model in a matched relationship in a TMJ motion simulator;
jointly scanning the first and second halves of the dental model in the matched relationship in the TMJ motion simulator with the scanner and storing resulting scanned data in the electronic memory unit; and
consolidating the first scanned data from the first half, the second scanned data from the second half, and the scanned data from the jointly scanned first and second halves to form the image of the dental model.

13. The method according to claim 12, wherein the placing step comprises manually positioning and matching the first and second halves in the matched relationship.

14. The method according to claim 12, which comprises matching the first and second halves in an articulator.

15. The method according to claim 12, which comprises mathematically consolidating the scanned data with a computer program to form the image of the dental model.

16. The method according to claim 12, wherein the scanned data correspond in each case to a point set.

17. The method according to claim 12, which comprises consolidating the scanned data automatically by a computer program or by an operator.

18. The method according to claim 12, which comprises displaying at least one of the individual scanned data and the consolidated image of the dental model on a screen for viewing by an operator.

19. The method according to claim 12, which comprises feeding the scanned data and/or the image of the dental model to a memory unit and storing the data and/or the image in the memory unit.

20. The method according to claim 19, wherein the memory unit is an internal memory unit inside the device or an external memory unit.
